(19) United States
(12) Patent Application Publication
(10) Pub. No.: US 2008/0246397 A1
(43) Pub. Date: Oct. 9, 2008

(54) MANUFACTURING METHOD OF WHITE LIGHT LED AND STRUCTURE THEREOF

(76) Inventors: Bily Wang, Hsin Chu (TW); Jonnie Chuang, Hsin Chu (TW); Chia-Hung Chen, Hsin Chu (TW)

Correspondence Address: HDSL, 4331 STEVENS BATTLE LANE, FAIRFAX, VA, 22033, US

(21) Appl. No.: 11/696,220

(22) Filed: Apr. 4, 2007

(51) Int. Cl. H01J 99/00; H01J 9/26

(52) U.S. Cl. 313/512; 445/23

(57) ABSTRACT

A manufacturing method of white light LED and a structure thereof include first, a substrate being prepared to be formed as a consecutively connected holder, on a first electrode of which non-conductive fluorescent glue is coated to form a fluorescent layer, on which a blue light chip is fixed; second, two conducting wires being welded onto the chip and electrically connected to both the first electrode and the second electrode of the holder respectively, finally, glue body encapsulating the holder, the fluorescent layer, the chip, and the two conducting wires to form a photic zone, over which a frame body encloses; furthermore, a window being formed on the frame body and provided for making the photic zone exposed. When blue light chip is excited to generate blue light, which will further excite the fluorescent layer to emit yellow light, then both blue light and yellow light will be dispersed through the photic zone to generate a uniform light source, which may output light longitudinally and collectively, making the output power promoted notably and the lightness enhanced significantly.

### BACKGROUND OF THE INVENTION

1. Field of the Invention

The present invention generally relates to a light emitting diode (LED), in particular, to a manufacturing method of white light LEDs.

2. Description of Prior Art

In current market, white light LED is comprised of different colors of LED or fluorescent powders to emit various colors other than white color, then these colors are mixed again to generate white color. However, in terms of lighting lifetime, since its structurally packaging materials are mainly comprised of transparent chemical resin, which is capable of resisting vibration and impact, so its lifetime can exceed 10,000 hours, which is several times over that of traditional fluorescent lamp or tungsten-filament bulb. Another advantage of white light LED is that its power consumption is only about ⅓˜⅕ of common tungsten-filament bulb. In today, when energy's price is high, power saving is a notable incentive for comprehensively applying LED, so LED is currently regarded as a major light source for the future, while it has been comprehensively used in liquid crystal TV, cellular phone, PDA, GPS display panel, digital camera, and lightings of automobile, office, home.

The so-called “white light” is usually comprised of lights of multiple colors. That is, the white light commonly seen by human eyes includes at least two color lights of different wavelengths; for example blue light adding yellow light may become a white light resulted from two complementary wavelengths, or a white light of three complementary wavelengths may be comprised by blue light, green light, and red light. In our daily lives, no matter indoors or outdoors, where a light source is needed, it is always desired to get an irradiance of light source resembled to sun light. Therefore, white light LED is also requested to have similar optical spectrum, color rendering, and color temperature as those of sun light for satisfying the daily life requirement of illumination. Furthermore, under different requirements of illumination, the lightness, color rendering, color, and color temperature are also different, for example the illumination requirement among family, office, and factory being absolutely different, family needing warm white light of low color temperature similar to the light of tungsten-filament bulb, while factory and office building needing illumination of high color temperature. In addition, in terms of backlight source in liquid crystal display (LCD), the requiring specification for light source is the sufficiency of gamut. Therefore, the pursuit of multiple light sources is an urgent target for industry, academy, and research.

According to manufacture materials, the white light LED may be divided into organic LED and inorganic LED. Currently, there are two lighting mechanisms for white light source made of inorganic semiconductor:

1. A white light lighting module, which is comprised by LED crystal particles in colors of red, blue, and green, has the advantages of high lighting efficiency and high color rendering. In the meantime, according to different epitaxy materials, the color of crystal particle is also different, so is the voltage characteristics, making this method with expansive cost and complicatedly controlling wire design. In the meantime, it is difficult to achieve a white light by mixing three color lights, which is one of many problems needed to be solved in this method.

2. Blue light LED generates white light LED by means of exciting yellow YAG fluorescent powder, which is a mainstream in current market. In this method of manufacturing white light LED, optic glue mixed with yellow YAG fluorescent powders is filled around blue light LED chip, which is capable of emitting blue light with wavelength approximately 400-530 nm, this light generated from blue light LED chip making yellow fluorescent powder generate yellow light but, in the meantime, part of this blue light with appropriate percentage penetrates outwardly to match with yellow light emitted from fluorescent powder to generate white light resulted from two complementary wavelengths of blue and yellow colors.

However, there are several drawbacks in manufacturing this white light LED formed by the combination of blue light LED chip and yellow fluorescent powder:

1. Since blue light occupies most lighting spectrum, phenomena of higher color temperature and non-uniformity are occurred.

2. Since the lighting wavelengths of blue light LED will be changed following the raise of temperature, a light floating phenomenon of white light source is further created.

3. Furthermore, since the intensity of red color part in its lighting spectrum is weaker, a phenomenon of poor color rendering is created when a red color can not be completely shown during an object being illuminated.

### SUMMARY OF THE INVENTION

So, regarding traditional drawbacks, the present invention is to provide an innovative LED capable of generating white light, the output power of which is notably large without the drawbacks of higher color temperature and non-uniformity, the occurrence of color floating of light source in generating white light, and the problem of poor color rendering.

The manufacturing method of white light LED and structure thereof according to the present invention, comprising:

First, a metallic substrate is prepared, which is formed as a holder consecutively connected by plural first electrodes and plural second electrodes, on both of which plural perforations are formed.

Second, fluorescent layer is constructed on the holder, wherein insulated fluorescent glue is coated on the first electrode to form a fluorescent layer.

Third, a chip capable of generating blue light is fixed on the fluorescent layer, after the chip being fixed, two conducting wires being welded onto the chip and respectively being electrically connected to first electrode and second electrode.

Fourth, glue is applied to encapsulate the holder, fluorescent layer, chip, and conducting wires, and thus a photic zone is formed, making part of first electrode and second electrode exposed to the outside of photic zone.

Finally, the photic zone is covered by a frame body, on which a window is formed and provided for making photic zone exposed and also making part of first electrode and second electrode exposed to the outside of frame body.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a holder forming illustration of the white light LED according to the present invention;

FIG. 2 is an illustration of fluorescent layer coated upon the holder according to the present invention;

FIG. 3 is an illustration for welding conducting wires and fixing chip upon the fluorescent layer according to the present invention;

FIG. 4 is an illustration for packaging the glue body according to the present invention;

FIG. 5 is an illustration for packaging the frame body according to the present invention;

FIG. 6 is a cross-sectional illustration of the white light LED according to the present invention.

### DETAILED DESCRIPTION OF THE INVENTION

In cooperation with attached drawings, the technical contents and detailed description of the present invention will be as follows.

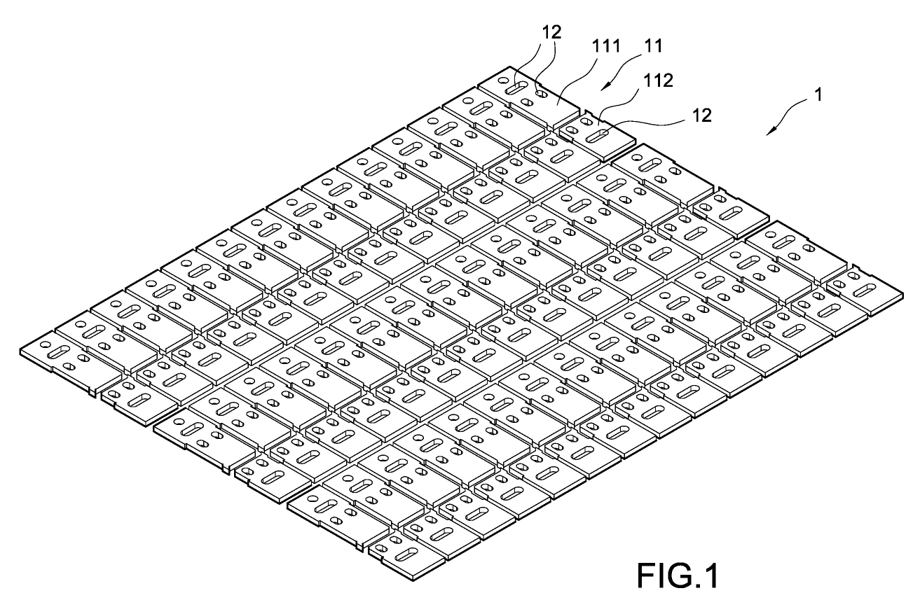

Please refer to FIG. 1, which is a holder forming illustration of the white light LED according to the present invention. As shown in the figure, the manufacturing method of a white light LED according to the present invention is described as following. First, a metallic substrate 1 is prepared, on which a holder 11, consecutively connected by plural first electrodes 111 and plural second electrodes, are formed by etching or pressing technique, plural perforations 12 being formed upon the first electrode 111 and second electrode 112. In the subsequent processes, when photic zone (not shown in the figure) or frame body (not shown in the figure) of LED are thermally pressed and formed, plastic materials may penetrate through the perforations 12, making the resin of frame body or photic zone firmly connected to the holder 11.

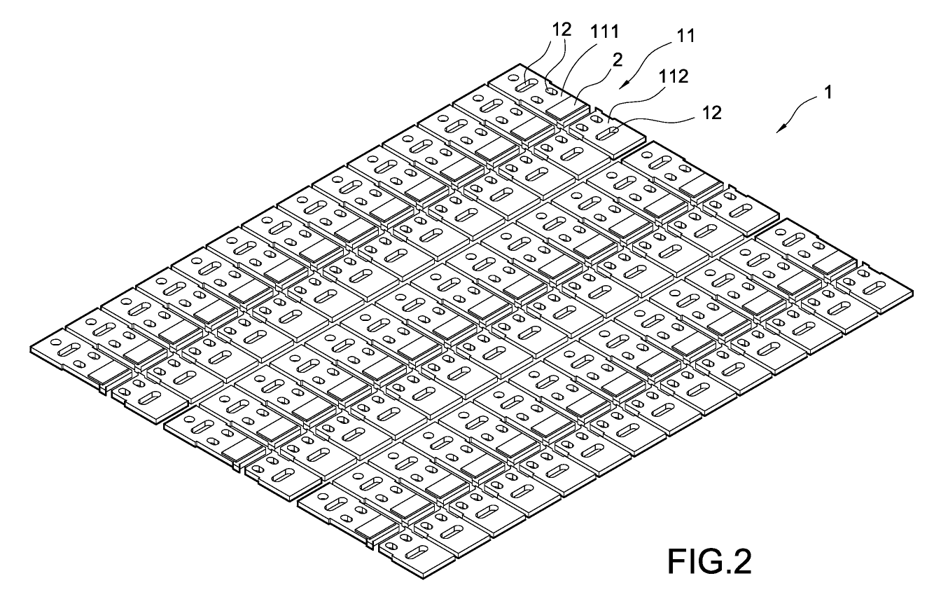

Please refer to FIG. 2, which is an illustration for coating fluorescent layer upon the holder according to the present invention. As shown in this figure, fluorescent layer 2 is coated upon the holder 11 constructed according to the processing steps of FIG. 1. Non-conductive glue is made by uniformly mixing yellow fluorescent powder in appropriate quantity with one of insulated liquid EPOXY, silicone, or non-conducting glue. The fluorescent layer 2 is built by forming the non-conductive fluorescent glue upon the first electrode 111 of the holder 11 by means of web-printing technique or mould-pressing manner.

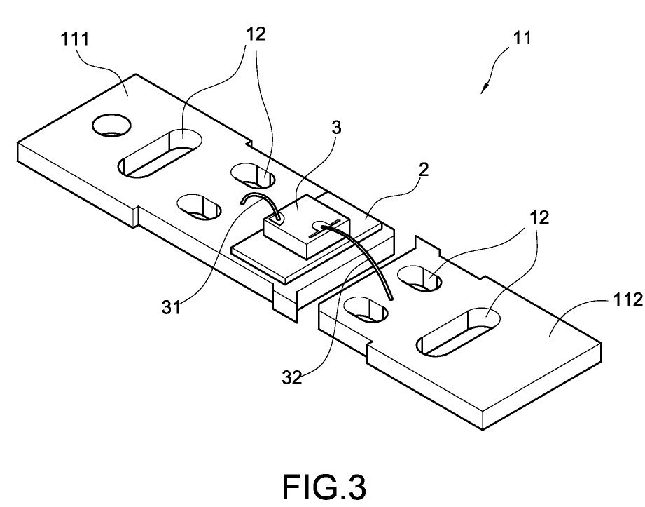

Please refer to FIG. 3, which is an illustration for welding conducting wires and fixing chip upon the fluorescent layer according to the present invention. As shown in this figure, after the fluorescent layer 2 has been coated upon the first electrode 111 of the holder 11, a chip 3 capable of generating blue light is fixed thereon. Two conducting wires 31, 32 are subsequently welded onto the chip 3 and electrically connected to the first electrode 111 and second electrode 112 respectively. When two conducting wires 31, 32 are electrically conducted, the chip 3 will generate blue light, which will further excite the fluorescent layer 2 to emit yellow light, and both blue light and yellow light can be mixed to become white light.

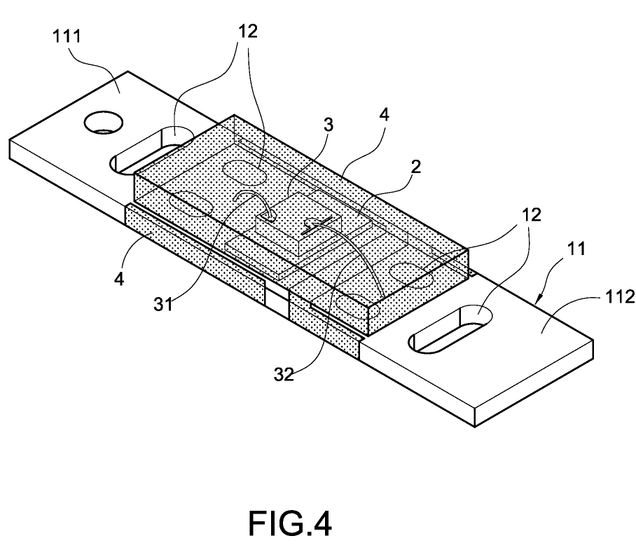

Please refer to FIG. 4, which is an illustration for packaging the glue body according to the present invention. As shown in this figure, after the chip fixation and wiring procedure, a photic zone 4 is further formed to encapsulate the holder 11, fluorescent layer 2, chip 3, and conducting wires 31, 32. The photic zone 4 is made of glue body composed of dispersant with one of silicone or EPOXY. The glue body is thermally pressed upon the holder 11, fluorescent layer 2, chip 3, and conducting wires 31, 32, to form a photic zone 4, making part of the first electrode and the second electrode 112 exposed to the outside of photic zone 4.

The dispersant, added to the silicone or EPOXY, excites the blue light and yellow light, both of which will be reflected and vibrated, such that they may be mixed uniformly to become white light. In the meantime, the lights will be concentrated longitudinally to make the output power promoted notably and the lightness enhanced significantly.

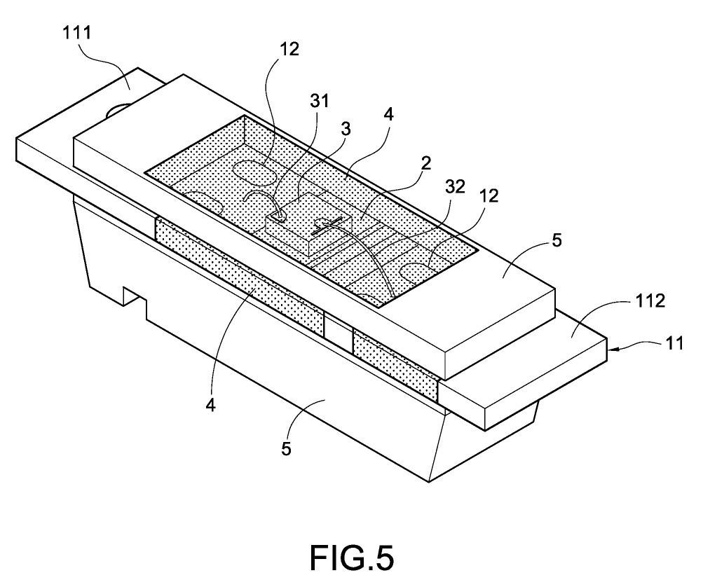

Please refer to FIG. 5, which is an illustration for packaging the frame body according to the present invention. As shown in the figure, after the photic zone 4 is packaged, a frame body 5 further packaged over photic zone 4 is made of materials mixed by EPOXY and white titanium, which are thermally pressed into frame body 5 packaged over the photic zone 4. In the meantime, there is a window 51 formed above the frame body 5 for making the photic zone 4 exposed and also making part of the first electrode 111 and the second electrode 112 exposed to the outside of frame body 5.

The frame body 5 is provided for the reflection of the light source beside the LED, making the output power promoted notably and the lightness enhanced significantly.

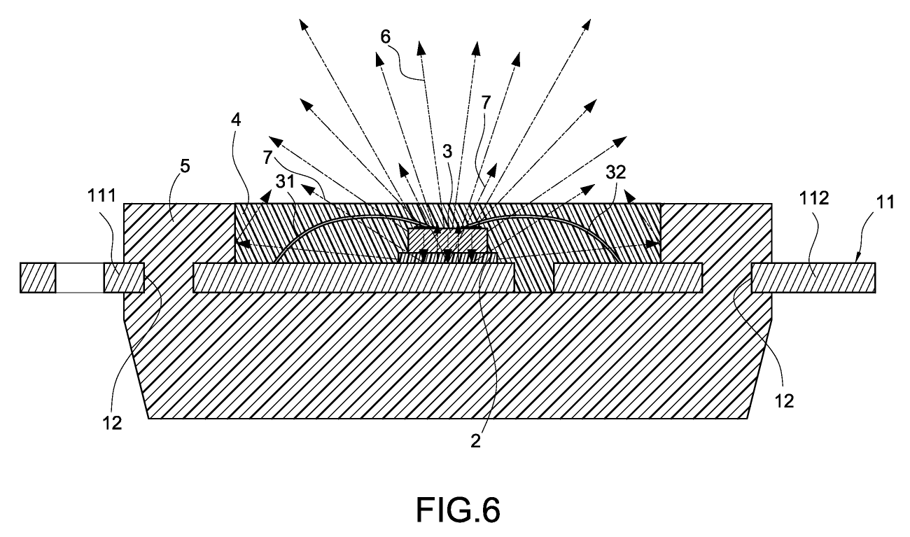

Please refer to FIG. 6, which is a cross-sectional illustration of the white light LED according to the present invention. As shown in this figure, blue light chip 3 is excited to generate blue light in longitudinal, side, and reversal directions. The reversal blue light 6 may excite fluorescent layer 2 to emit yellow light 7, while photic zone 4 may disperse both the blue light 6 and yellow light 7 to make the light source uniformed and output light longitudinally and collectively, and thus the output power is promoted notably and the lightness is enhanced significantly. In the meantime, when the light source in side direction is reflected by the frame body 5 to be output longitudinally and collectively, the output power and the lightness similarly will be increased notably without higher color temperature and non-uniformity, or the occurrence of color floating in light source, or the problem of poor color rendering.

Aforementioned description is only preferable embodiment according to the present invention, being not used to limit its executing scope. Any equivalent variation and modification made according to appended claims is all covered by the claims claimed by the present invention.

What is claimed is:

1. A structure of white light LED, comprising:
a holder, on which a first electrode and a second electrode are arranged;
a fluorescent layer, which is arranged onto the first electrode;
a blue light chip, which is arranged onto the fluorescent layer;
two conducting wires, which are electrically connected to the first electrode and the second electrode respectively; and
a photic zone, which encapsulates the holder, the fluorescent layer, the blue light chip, and the two conducting wires.

2. The structure of white light LED according to claim 1, wherein a plural perforations are formed upon the first electrode and the second electrode.

3. The structure of white light LED according to claim 1, wherein the fluorescent layer is made by combining yellow fluorescent powders with one of insulated liquids of resin, silicone and non-conductive glue.

4. The structure of white light LED according to claim 3, wherein the resin is EPOXY.

5. The structure of white light LED according to claim 1, wherein the photic zone is made by combining dispersant with one of silicone and resin.

6. The structure of white light LED according to claim 5, wherein the resin is EPOXY.

7. The structure of white light LED according to claim 1, wherein a frame body is covered over the photic zone.

8. The structure of white light LED according to claim 7, wherein the frame body is made by mixing resin with titanium.

9. The structure of white light LED according to claim 8, wherein the resin is EPOXY.

10. The structure of white light LED according to claim 8, wherein the color of the titanium is white.

11. A method for manufacturing the structure of white light LED according to claim 1, comprising:
a). preparing a substrate;
b). the substrate being formed as a holder having plural first electrodes and plural second electrodes, both of which are consecutively connected;
c). a fluorescent layer being coated upon the first electrode;
d). a blue light chip being fixed upon the fluorescent layer;
e). two conducting wires being welded onto the chip and electrically connected to the first electrode and the second electrode respectively;
f). a glue body encapsulating the holder, the fluorescent layer, the chip, and the conducting wires to form a photic zone.

12. The method according to claim 11, wherein the substrate in step a) is a metallic material.

13. The method according to claim 11, wherein the fluorescent layer in step c) is made by combining yellow fluorescent powders with one of insulated liquids of resin, silicone, and non-conductive glue.

14. The method according to claim 13, wherein the resin is EPOXY.

15. The method according to claim 11, wherein the glue body is made by combining dispersant with one of silicone and resin.

16. The method according to claim 15, wherein the resin is EPOXY.

17. The method according to claim 11 wherein, after step f), a frame body is covered over the photic zone.

18. The method according to claim 17, wherein the frame body is made by mixing resin with titanium.

19. The method according to claim 18, wherein the resin is EPOXY.

20. The method according to claim 18, wherein the color of the titanium is white.
